(19) United States
(12) Patent Application Publication
(10) Pub. No.: US 2017/0338534 A1
(43) Pub. Date: Nov. 23, 2017

(54) LITHIUM ION BATTERY

(71) Applicant: BorgWarner Ludwigsburg GmbH, Ludwigsburg (DE)

(72) Inventors: Andrew Duncan Sutherland, Birmingham, MI (US); Christopher John Mays, Bloomfield, MI (US)

(21) Appl. No.: 15/161,211

(22) Filed: May 21, 2016

(51) Int. Cl. H01M 10/6553; H01M 10/625; H01M 10/0525; H01M 10/615; H01M 2/10; H01M 10/623

(52) U.S. Cl. CPC H01M 10/6553; H01M 2/1094; H01M 10/623; H01M 10/0525; H01M 10/615; H01M 10/625; H01M 2220/20; H01M 2220/30

(57) ABSTRACT

A lithium ion battery includes a plurality of cells, each comprising a positive electrode, a negative electrode and an electrolyte. The electrolyte includes a lithium salt and contacts the positive and the negative electrode. The lithium ion battery includes a heating layer made of a PTC polymer. In another embodiment, a lithium ion cell includes an electrolyte comprising a lithium salt, a positive electrode in contact with the electrolyte, a negative electrode in contact with the electrolyte, and a heating layer made of a PTC polymer.

### CROSS-REFERENCE TO RELATED APPLICATIONS

None

### DESCRIPTION

### Field of the Invention

The invention relates to a lithium ion battery.

### Background of the Invention

Lithium ion batteries comprise a positive electrode, a negative electrode and an electrolyte which comprises a lithium salt and contacts the electrodes. Lithium ion batteries are known, e.g., from US 2012/0082893 A1 which is incorporated herein by reference.

Lithium ion batteries lose performance if it is too hot or too cold. When used in a vehicle, winter weather and freezing temperatures can adversely affect battery operation. It has been tried to heat vehicle batteries by means of cooling fluid which transports waste heat away from a vehicle motor. Such cooling fluid can run through channels provided in the battery for this purpose. However, such cooling fluid is rather cold at the beginning of driving when heating is needed the most.

Another possibility is to heat batteries electrically by means of heating devices comprising heating elements made of materials like nickel-chrome. A disadvantage of such heating devices is significant costs, problems of achieving efficient heat transfer and a need of monitoring to prevent overheating.

### SUMMARY OF THE INVENTION

An object of the present invention is to provide an improved lithium ion battery for vehicles.

This object is solved by providing a lithium ion battery with a heating layer made of a PTC polymer. Such a layer can be provided in any shape even on a curved surface. Therefore a heating layer made of PTC polymer can be applied easily to any shape of a battery or battery cell. For example, a PTC polymer may be printed or provided as a sheet that is fixed by means of an adhesive. Moreover, PTC polymers show a marked increase of the electrical resistance at a critical temperature. The electrical resistance of a PTC polymer's low temperature state and the electrical resistance of its high temperature state may differ by a factor of 100 or more. By choosing a PTC polymer with a suitable critical temperature, an inherent protection from overheating is possible without the need for complex devices.

The PTC polymer can be a mixture comprising carbon black particles and a polymer, e.g. polyethylene, polyvinylidene fluoride or other thermoplastic polymer. The significant change in electrical resistance upon heating above a critical temperature is believed to be caused by a phase transition of the polymer material. In the low temperature state, the polymer of the mixture is believed to form a crystalline phase where the carbon black particles are present in grain boundaries between crystalline grains. Thereby the carbon black particles form electrically conducting chains throughout the material causing the overall resistance of the material to be relatively low. In the high temperature state, the grains expand thereby disrupting the chains and/or the polymer is no longer crystalline but in an amorphous phase in which the carbon black particles are soluble. The carbon black particles then no longer form electrically conducting chains of sufficient length to provide conducting paths throughout the whole material and the electrical resistance of the PTC polymer is rather high.

The temperature range in which the PTC polymer transitions form the low temperature phase to the high temperature phase depends on the polymer, e.g. polyethylene or polyvinylidene. The temperature at which the polymer transitions from a crystalline phase into an amorphous phase can be adjusted with additives that are soluble in it, e.g. oils or esters.

The heating layer can be provided on a casing of the battery containing a plurality of cells. Another possibility is to provide each cell of a lithium ion battery with a heating layer made of a PTC polymer. Thereby heat can be transferred very effectively to each cell.

The PTC polymer may be arranged on a surface of a container of the cell. Especially cells comprising a liquid electrolyte, e.g. a lithium salt in an organic solvent, need a container and thereby provide a good place for the heating layer. Another possibility is to arrange the PTC polymer on one of the electrodes of the cell. This can be especially advantageous in polymer lithium ion batteries which use a polymer electrolyte instead of a liquid electrolyte, e.g. pouch cells.

In an embodiment of the invention, the PTC polymer may cover a first surface of the cell, but not a second surface of the cell. For example, a front face of the cell may be covered by the PTC polymer and a back face may be free of the PTC polymer. The second surface may then be used for cooling.

An electrical insulator might be placed below the heating layer. However, such an insulator can be avoided, e.g. if a terminal for electrically contacting the heating layer is buried in the PTC polymer, especially if the buried terminal is on the same potential as the electrode of the cell, for example on ground potential. Instead of burying one or two terminals in the PTC polymer, the PTC polymer might also be electrically contacted by terminals, e.g. metal sheets or films, above and/or below the heating layer.

Further details and advantages of the invention are explained in the following with reference to the enclosed figures.

### BRIEF DESCRIPTION OF THE DRAWINGS

The accompanying drawings illustrate the invention. In such drawings:

FIG. 1 shows schematically an embodiment of a lithium ion battery with a heating layer made of a polymer PTC;

FIG. 2 shows schematically an embodiment of a lithium ion cell with a heating layer made of a polymer PTC; and

FIG. 3 shows schematically another embodiment of a lithium ion cell with a heating layer made of a polymer PTC.

### DETAILED DESCRIPTION OF THE PREFERRED EMBODIMENTS

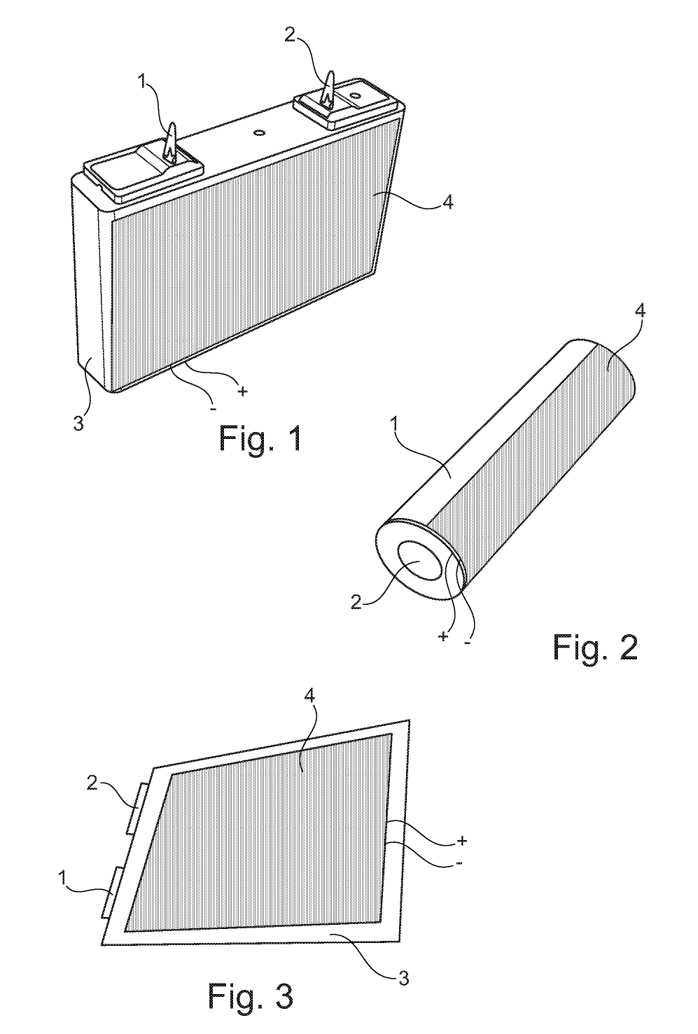

FIG. 1 shows a lithium ion battery comprising a positive electrode 1, a negative electrode 2, a casing 3 containing an electrolyte, e.g. a lithium salt in an organic solvent, and a heating layer 4 provided as PTC polymer. The lithium salt may be lithium hexafluorophosphate (LiPF6), lithium hexafluoroarsenate monohydrate (LiAsF6), lithium perchlorate (LiClO4), lithium tetrafluoroborate (LiBF4), or lithium triflate (LiCF3SO3), for example.

In the embodiment shown, the PTC polymer heating layer 4 is provided on an outer surface of the casing 3. Another possibility is to provide the PTC polymer heating layer 4 on an inside surface of the casing 3. A PTC polymer heating layer on an inner surface of the casing may offer the advantage of improved thermal coupling. A PTC polymer heating layer on an outer surface of the casing may offer the advantage of an easy electrical connection of the PTC polymer heating layer.

The terminals for applying a voltage to the PTC polymer heating layer 4 may be made of sheet metal on top and below the PTC polymer heating layer 4. Heating current will then flow in a direction perpendicular to the PTC polymer heating layer 4. Another possibility is to bury one or several conductors in the PTC polymer heating layer 4 to provide a terminal. Heating current will then flow lengthwise within the plane of the PTC polymer heating layer 4.

It is possible to apply the PTC polymer heating layer 4 on opposing sides of the casing 3. Thereby heating power can be increased. There may be separate PTC polymer heating layers on different sides of the casing 3 or a single layer that may circumvent the lithium ion battery or cell. In the embodiment shown, the PTC polymer heating layer 4 is applied only on one of the sides of the casing 3 so that the opposite side of the casing is available for cooling the battery or cell.

In FIG. 1, the casing 3 is a cuboid or more generally a prism. However, the casing may also have any other shape.

FIG. 2 shows a lithium ion cell comprising a cylindrical body. Electrodes 1, 2 are sheets. A lithium salt comprising electrolyte is present inside the body. The electrolyte may be a liquid that is enclosed a container or a polymer. The PTC polymer heating layer 4 is applied on the outside of the cell, but may also be applied on the inside. In the embodiment shown, the PTC polymer heating layer 4 covers about half of the lateral surface of the cell.

FIG. 3 shows a pouch cell comprising a pouch, e.g. container made of flexible film or foil, wherein an electrolyte and electrodes are arranged. The electrolyte may be a lithium salt in a solvent or in a polymer. Foil tabs are connected, e.g. by soldering or welding, to the electrodes and brought to the outside in a fully sealed way.

A plurality of cells can be connected to form a battery or lithium ion accumulator.

Although several embodiments have been described in detail for purposes of illustration, various modifications may be made to each without departing from the scope and spirit of the invention. Accordingly, the invention is not to be limited, except as by the appended claims.

What is claimed is:

1. A lithium ion battery, comprising:
a plurality of cells, each cell comprising a positive electrode, a negative electrode and an electrolyte;
wherein the electrolyte comprises a lithium salt and contacts the positive and the negative electrode; and
a heating layer made of a PTC polymer.

2. The lithium ion battery according to claim 1, wherein the PTC polymer is a mixture comprising carbon black particles and a polymer.

3. The lithium ion battery according to claim 2, wherein the polymer is a thermoplastic polymer.

4. The lithium ion battery according to claim 2, wherein the polymer is polyethylene or polyvinylidene flouride.

5. The lithium ion battery according to claim 1, wherein the heating layer is provided on each cell.

6. The lithium ion battery according to claim 5, wherein a first side of each cell is covered by the heating layer and a second side of each cell is free of the heating layer.

7. The lithium ion battery according to claim 5, wherein each cell comprises a container in which the electrolyte is arranged, the heating layer being arranged on a surface of the container.

8. The lithium ion battery according to claim 5, wherein the PTC polymer is arranged on at least one of the electrodes of each cell.

9. The lithium ion battery according to claim 1, wherein a plurality of cells is arranged in a casing and the heating layer is arranged on a surface of the casing.

10. The lithium ion battery according to claim 1, wherein the PTC polymer has a low temperature crystalline state and a high temperature amorphous state, and wherein the PTC polymer changes from the low temperature state to the high temperature state in a temperature range between 40° C. and 130° C.

11. The lithium ion battery according to claim 1, wherein terminals for applying a voltage to the PTC polymer are buried in the PTC polymer.

12. A lithium ion cell, comprising:
an electrolyte comprising a lithium salt;
a positive electrode in contact with the electrolyte;
a negative electrode in contact with the electrolyte; and
a heating layer made of a PTC polymer.

13. The lithium ion cell according to claim 12, wherein the cell is a pouch cell.
